(19) United States
(12) Patent Application Publication
(10) Pub. No.: US 2022/0267012 A1
(43) Pub. Date: Aug. 25, 2022

(54) Two-Piece Mounting Rail For A Vehicle

(71) Applicant: Premium Aerotec GmbH, Augsburg (DE)

(72) Inventors: Cord Haack, Augsburg (DE); Carsten Paul, Augsburg (DE); Bernhard Hörger, Augsburg (DE)

(73) Assignee: Premium Aerotec GmbH, Augsburg (DE)

(21) Appl. No.: 17/679,287

(22) Filed: Feb. 24, 2022

(30) Foreign Application Priority Data
Feb. 25, 2021 (DE) 10 2021 104 500.2

(51) Int. Cl. B64D 11/06; B64D 41/00

(52) U.S. Cl. CPC B64D 11/0696; B64D 41/00

(57) ABSTRACT

A mounting rail for receiving and holding loads in an interior of a vehicle includes a support element with a recess extending in the longitudinal direction of the support element and a rail element. The rail element is arranged in the recess of the support element and is mechanically coupled to the support element. The rail element has a receiving space for receiving and holding loads. The mounting rail is divided into two parts so that different materials can be used for the support element and the rail element, which meet the respective individual requirements hereof.

### TECHNICAL FIELD

The present description relates to a mounting rail for receiving and holding loads in an interior of a vehicle, in particular in the interior of an aircraft.

### TECHNICAL BACKGROUND

Mounting rails are typically used in the cabin of aircrafts to accommodate and hold in position a wide variety of interior furnishing elements (generally: loads). For example, mounting rails are used to mount the seats in a passenger aircraft in a desired position. In this use, mounting rails are therefore referred to as seat rails.

However, such mounting rails can also be used to accommodate other interior furnishings and hold them in a desired position. For example, partition walls can be fixed in a mounting rail. Entire furnishing modules, such as those found in a galley or a toilet unit, can also be fixed in a mounting rail.

Mounting rails are typically installed in the floor of the cabin. However, mounting rails may also be located on or in a side wall or ceiling of the cabin to provide multiple attachment points for an element to be mounted.

A mounting rail offers a large degree of flexibility with regard to the structure of the interior as well as to the elements it contains. It is usually possible to move the elements to be fastened in the mounting rail in the longitudinal direction or to remove them from the mounting rail and insert them in another position.

The mounting rails are often provided with a standardized rail grid. Several notches recurring at regular intervals are provided to facilitate the placement and fixation of elements to be fastened.

Typically, a mounting rail extends over most or even all of the interior of an aircraft, thus passing through areas of the cabin dedicated to different uses.

### DESCRIPTION

It may be considered as an objective to provide a mounting rail which can be used for different purposes in different environments in the interior of a vehicle.

This objective is solved by the object of the independent claim. Further embodiments will be apparent from the dependent claims and from the following description.

According to a first aspect, a mounting rail for receiving and holding loads in an interior of a vehicle is disclosed. The mounting rail includes a support member and a rail member. The support member includes a recess extending longitudinally of the support member. The rail member is disposed in the recess of the support member and is mechanically coupled to the support member. The rail member has a receiving space for receiving and holding loads.

This means that the mounting rail described herein is divided into two parts or consists of two separate elements that can be assembled in a modular fashion. Therefore, the mounting rail can be assembled individually according to different requirements and in relation to a defined section. For example, the mounting rail described herein can be used to achieve requirements that cannot be achieved or can only be achieved with difficulty with a one-piece mounting rail. For example, the support member can be made of a material with a lower specific weight than the rail member, whereas the rail member, as a component facing the interior of the vehicle, meets requirements such as mechanical strength, corrosion resistance, etc., and for this purpose can be made of a material which has a higher specific weight than the support member.

Different rail members can be inserted into the support member along different longitudinal sections of the mounting rail, thereby meeting the changing requirements in a vehicle interior. The support member may be made of the same material throughout, whereas the rail member is inserted according to local or site requirements. For example, a different rail member may be used in a wet area of an aircraft than in a passenger seating area. It is also conceivable that a blind element is used as the rail member, in those sections where no external elements need to be coupled to the mounting rail. Here, the rail member merely has the purpose of covering the support member.

The mounting rail described herein can be used particularly advantageously in a wall or the floor of vehicles, in particular of aircrafts. In this case, the support member is connected to a carrying structure of the vehicle.

The recess of the support member extends over at least a portion of the support member in the longitudinal direction thereof. In this regard, the recess forms an elongated channel-like depression or groove.

The support member is typically longer than the rail member, such that the rail member is preferably received in the recess of the support member along its entire length. This helps to ensure that a force transmitted to the rail member can be advantageously transmitted to the support member and the carrying structure of the vehicle.

For example, the support member may extend along most or all of the length of the interior of a vehicle and the recess is equipped with a matching rail member as required. This assembly of the mounting rail allows the mounting rail to be modularly assembled from support members and rail members of different structures and designs, and even using different materials.

The support member builds the interface with the carrying structure of the vehicle and the rail member builds the interface with the load to be supported. The support member and the rail member may each be configured such that their properties are adapted to the corresponding function as interface member to the carrying structure and the load to be accommodated, respectively.

According to an embodiment, the support member is made of a first material and the rail member is made of a second material, wherein the first material is a different material than the second material.

In other words, the support member and the rail member are made of different materials with different material properties. For example, the rail member may be designed as a high static strength head and the support member may be designed as a lightweight and rigid carrying structure. For example, the support member may be an extruded aluminum structure and the rail member may be a titanium insert.

The first material differs from the second material in that these materials have different compositions and/or different properties. For example, the first material of the support member is aluminum or an aluminum alloy, or a composite material, such as a carbon fiber-reinforced plastic in which carbon fibers are embedded in a plastic matrix, using as a matrix, for example, an epoxy resin, thermosets, or thermoplastics. The second material may be, for example, titanium or a titanium alloy.

This design allows the mounting rail to be adapted to the requirements of the respective environments by using a suitable rail member made of a suitable first material, but the support member is made of the same second material over the entire length of the mounting rail. Overall, this allows the weight of the mounting rail to be reduced in its entirety without having to sacrifice the material properties required there at the interface with the cabin, i.e., at the rail member.

In a wet area, for example, a rail member made of titanium or a titanium alloy can be used, which offers advantageous corrosion protection and high mechanical strength, for example. Nevertheless, it is not necessary to use the comparatively expensive and heavy material titanium for the entire mounting rail. The support member can further be made of aluminum or a carbon fiber-reinforced plastic because the support member is arranged behind an outer surface of the vehicle interior and is thus protected to some extent from external influences or damage.

According to another embodiment, the support member comprises at least one material selected from the group consisting of: Aluminum, an aluminum alloy, a plastic, a carbon fiber reinforced plastic, wherein the rail member comprises at least one material selected from the group consisting of: Aluminum, an aluminum alloy, titanium, a titanium alloy.

According to a further embodiment, the mounting rail comprises at least two support members arranged in the longitudinal direction of the mounting rail and adjacent to each other, wherein the support members are mechanically connected to each other such that the recesses of the support members join each other.

This structure allows flexible composition of the mounting rail to a desired length dimension. The resulting recess can be equipped with one or more rail members.

At the transition from one support member to the next support member, suitable mechanical connecting elements may be used to mechanically couple the two support members.

According to a further embodiment, the mounting rail has at least two rail members arranged in the recess.

The length of the individual rail members is independent of the length of the support members. A plurality of rail members may be arranged in the recess of a single support member. Similarly, a rail member may extend over two or more support members.

Since the mounting rail can be composed of a plurality of individual support members arranged in a row, these plurality of support members are regarded as a single component because the plurality of support members arranged in a row form a continuous longitudinal channel (the recess) into which one or more rail members can be inserted.

According to a further embodiment, the two rail members are configured differently.

As described above, the rail members are adapted to local requirements. In a wet area, a different material can be used for the rail member than in a passenger seating area.

Thus, the desired compromise of the required properties of the materials (e.g. mechanical strength, corrosion resistance, weight, etc.) can be used locally for the mounting rail in each case.

According to a further embodiment, the rail member is held in the support member in the form of a dovetail joint.

The rail member and the associated recess in the support member are shaped to correspond to each other. For example, the rail member is inserted longitudinally into the recess and the recess tapers upwardly (toward the opening of the recess) so that the rail member cannot be lifted out of the recess. Due to the shape of the recess (i.e., the cross-section of the recess), the rail member can move in the recess only in the longitudinal direction of the recess.

According to a further embodiment, the rail member is fixed in the recess of the support member by one or more fastening members so that movement of the rail member in the longitudinal direction of the recess is prevented.

The fastening members can create a reversible mechanical coupling between the rail member and the support member, thereby preventing movement in the longitudinal direction of the recess. Thus, the rail member is fixed in the recess in all directions. Screws, bolts or rivets, for example, can be used as fastening elements.

According to a further embodiment, the receiving space of the rail member is designed to form a first installation space for lines in addition to receiving loads.

According to a further embodiment, the receiving space of the rail member is designed to form a first installation space for conduits in addition to receiving loads.

In this installation space, for example, an electrical conduit or a cable guide can be arranged, via which electrical signals or energy are transmitted.

According to a further embodiment, the support member has two support legs extending away from the recess and configured to form and partially enclose a second installation space for conduits.

The support member is connected to the vehicle or a carrying member of the vehicle by means of the support legs. This creates a further installation space between the carrying member and the support member, so to speak below the support member, in which conduits and cables can be laid protected from external influences.

The mounting rail described herein relies on a two-piece design of the mounting rail. Instead of a one-piece rail, a two-piece rail with a support member and a rail member is proposed, wherein the support member and the rail member can initially be manufactured individually and with their own characteristics and can be combined or assembled to form the finished mounting rail according to local requirements.

### BRIEF DESCRIPTION OF THE FIGURES

In the following, examples of embodiments are described in more detail with reference to the accompanying drawings. The illustrations are schematic and not to scale. Identical reference signs refer to the same or similar elements. The figures show:

FIG. 1 a schematic representation of a mounting rail.

FIG. 2 a schematic representation of a support member.

FIG. 3 a schematic representation of a rail member.

FIG. 4 a schematic representation of a mounting rail below floor panels.

FIG. 5 a schematic representation of a mounting rail below floor panels.

FIG. 6 a schematic representation of a mounting rail below floor panels.

FIG. 7 a schematic representation of a mounting rail below floor panels.

FIG. 8 a schematic representation of a mounting rail.

FIG. 9 a schematic representation of a rail member with a load support of an external member to be mounted.

### DETAILED DESCRIPTION OF EXEMPLARY EMBODIMENTS

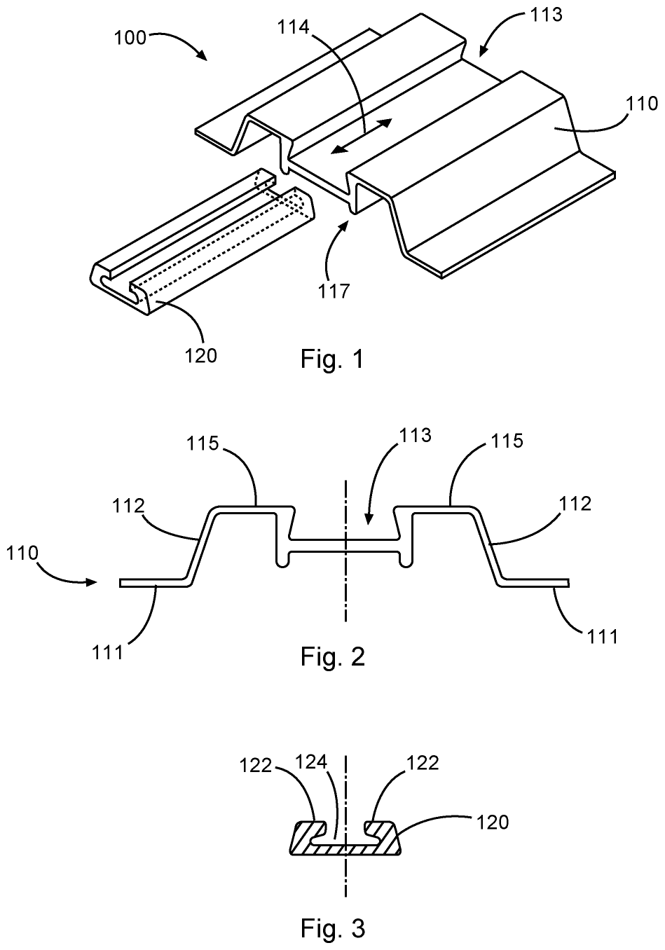

FIG. 1 shows a schematic isometric view of a mounting rail 100, which comprises a support member 110 and a rail member 120. The extension of the mounting rail 100 in the longitudinal direction 114 may vary and be adapted to external requirements. The support member 110 includes an elongated recess 113 extending in the longitudinal direction 114. The recess 113 provides a receiving space for the rail member 120. The rail member 120 is inserted into the recess 113 by inserting it into the recess 113 at a end face 117 and sliding it in the longitudinal direction 114.

To facilitate insertion of the rail member 120 into the recess 113, the surfaces of the recess may be provided with an appropriate surface treatment, for example sprayed with Teflon spray. Once the rail member 113 is in its intended position, it is secured in place. A sealant may also be used, which is placed between the rail member and the support member to prevent foreign matter from entering the recess 113 along the outer surfaces of the rail member. Foreign objects at this location can make it difficult to remove and replace the rail member.

The side walls of the recess 113 prevent the rail member from moving transversely to the longitudinal direction 114. The rail member 120 also cannot be removed or lifted out of the recess in an upward direction because the side walls of the recess slope upwardly, and the opening of the recess is narrower than the width of the recess at the bottom thereof. In other words, the recess has a lateral extent that decreases upward.

The lateral outer surfaces of the rail member are correspondingly beveled to conform to the cross-sectional shape of the recess. This configuration of the cross-section of the recess and the outer shape of the rail member is referred to as a dovetail joint.

FIG. 2 shows a frontal view of the end face 117 of the support member 110 of FIG. 1.

The support member 110 is an extruded structure made of aluminum, for example. In addition to the recess 113, the support member 110 has two support shoulders 115 laterally adjoining it, a support leg 112 on each support shoulder, and a mounting surface 111 at the end of each support leg. In this embodiment, the support member is symmetrical about its vertical axis.

In the frontal view of FIG. 2, the sloping side surfaces of the recess can be readily seen.

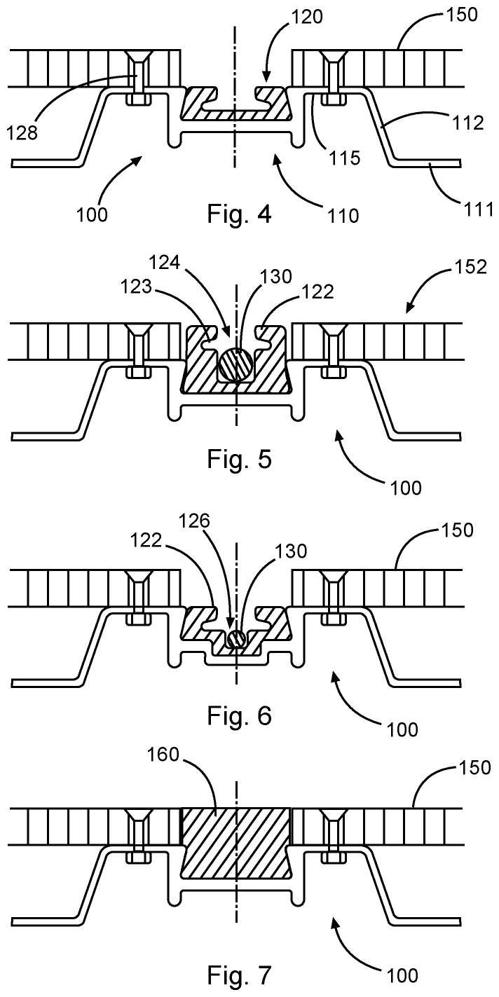

The support shoulder 115 serves to allow a wall or floor panel to be placed on and connected to the support member 110. Screws, bolts or rivets may be used for this purpose, for example. The corresponding structure is shown in detail in FIGS. 4 to 8.

The support legs 112 and the adjoining mounting surfaces 111 serve to connect the support member to a carrying structure of the vehicle.

FIG. 3 shows an illustration of the rail member 120 as it may be used with the support member 110 of FIG. 2 to provide a mounting rail 100 of FIG. 1.

The rail member 120 has a C-shaped profile, which is arranged with the opening facing upwards so that a load support of a member to be fixed can be inserted into the rail member 120 and fixed therein. For this purpose, the rail member 120 has two collars 122 that define and partially enclose a receiving space 124.

FIG. 4 shows the mounting rail 100 in an assembled state together with two wall panels 150 or floor panels 150, the panels 150 resting on the support shoulders 115 and leaving an access to the rail member 120. The panels 150 may be composite panels, for example. However, the type of panels may be of any type. Any materials and panels can be used with the mounting rail 100. The panels 150 are mechanically coupled to the support shoulder 115, for example, by a fastening member 128 in the form of a screw connected to the support shoulder 115. The support shoulders 115 have, at least section wise, a flat support surface on which the panels 150 rest. The support legs 112 extend from the support shoulders 115 away from the support surface for the panels and are fixed to the carrying structure 190 of the vehicle by means of the mounting surfaces 111.

In the illustration in FIG. 4, the rail member 120 is lowered relative to the upper surface of the panels 150.

FIG. 5 shows a variant of the mounting rail shown in FIG. 4 with a modified rail member 120. While the rail member 120 in FIG. 4 is recessed between the two panels 150, the rail member 120 in FIG. 5 has a greater height and the surface of the collar 122 is flush with an upper surface 152 of the panels. In the variant of FIG. 5, the receiving space 124 provides space for a conduit 130 that extends longitudinally of the rail member 120. The conduit 130 may serve as a signal cable or power cable for electronics, for example, disposed in a seat connected to the rail member 120.

A load support of an element to be fixed is placed in the lateral indentations 123 of the receiving space 124, so that no mechanical load is applied to the conduit 130.

FIG. 6 shows another variant for the design of the mounting rail 100. In FIG. 6, the rail member is recessed with respect to the panels 50, but a space for a conduit 130 is provided by the rail member having a downward bulge toward the support member. For this purpose, the support member 110 is also appropriately shaped to provide space for the conduit 130, which is located in the installation space 126.

FIG. 7 shows a section of the mounting rail in which no rail member with receiving space is arranged, but a blind element 160. The blind element can be used in such an area of the mounting rail in which no attachment of external elements is required. Thus, the blind element ensures that there is no depression at this point in which dirt can accumulate or which could pose a trip hazard. The surface of the blind element and the upper surface of the panels are at the same level, i.e., they are flush.

The mounting rail may comprise a plurality of longitudinal sections of support members 110 and a plurality of rail members disposed in the associated recess, with or without blind elements. Rail members of different materials and of different structure, and even blind elements of respective desired lengths, may be used in a support member to assemble a mounting rail in its entirety as required.

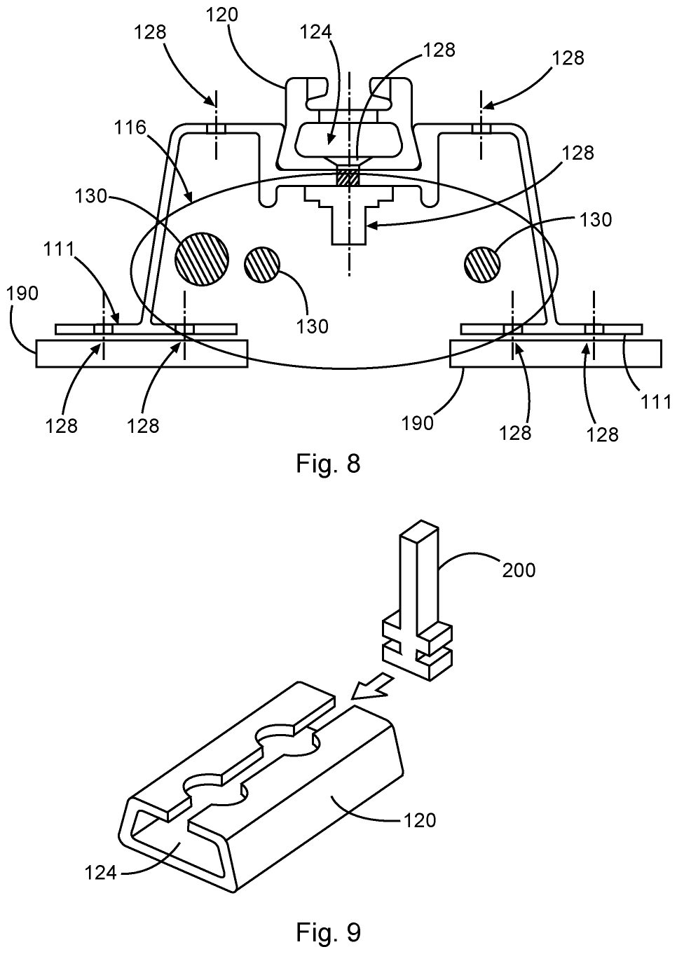

FIG. 8 shows another variant of the mounting rail 100. The support member 110 encloses with its support shoulders 115, support legs 112 and mounting surfaces 111 an installation space 116, in which one or more conduits 130 can be laid.

In FIG. 8, it is further shown that the mounting surfaces 111 are connected to a carrying structure 190 of a vehicle by means of fastening members 128 (screws, bolts, rivets, or the like). Fastening members 128 are also used to mechanically couple the panels resting on the support shoulders 115 to the support shoulders.

To prevent displacement of the rail member 120 in the longitudinal direction of the recess 113, the rail member 120 is connected to the support member 110 in a bottom region of its receiving space 124, by means of fastening members 128 arranged at regular or irregular intervals. In the example of FIG. 8, the fastening member 128 is a countersunk screw. However, other suitable fastening means such as bolts or rivets can also be used.

FIG. 9 shows a schematic representation of a rail member 120 whose collars are provided with a fastening grid. The fastening grid is provided in the form of lateral recesses in the collars of the C-profile of the rail member. A load support 200 of an external element (not shown) to be fastened is shown. This load support 200 is inserted into the receiving space 124 of the rail member 120 and secured in the desired position.

In one example, the mounting rail 100 as described herein may be constructed to use a titanium or titanium alloy rail member in a wet area. Titanium has a high specific gravity and moreover is very expensive. However, for strength reasons, it may be required that the rail member (the head of the mounting rail), which is used to support chair legs or monuments, be made of high-strength material with a standardized hole pattern. However, it is not necessary to use this high-strength, heavy and expensive material over the entire cross-section of the mounting rail. Rather, it is sufficient if the rail member meets these requirements. The support member may be made of a different material. The support member may be made of aluminum or a carbon fiber reinforced plastic, and the rail member is connected to the support member with fastening members, such as titanium bolts. The mounting rail described herein allows the combined use of carbon fiber reinforced plastics or thermoplastic materials in combination with metal, such as titanium. The rail member can even be replaced without having to remove the substructure, i.e., the support member. The rail member can also be made of or feature aluminum where lower strength requirements allow. With the mounting rail described herein, the use of heavy and expensive materials is reduced to a minimum.

Supplementally, it should be noted that “comprising” or “including” does not exclude other elements or steps, and “one” or “a” does not exclude a plurality. It should further be noted that features or steps that have been described with reference to any of the above embodiments may also be used in combination with other features or steps of other embodiments described above. Reference signs in the claims are not to be regarded as limitation.

### LIST OF REFERENCE SIGNS

100 mounting rail
110 support member
111 mounting surface
112 support leg
113 recess
114 longitudinal direction
115 support shoulder
116 installation space
117 end face
120 rail member
122 collar
123 lateral notch
124 receiving space
126 installation space
128 fastening member
130 conduit
150 wall panel or floor panel
152 surface
160 blind element
190 carrying structure
200 load support

1. A mounting rail for receiving and holding loads in an interior of a vehicle, the mounting rail comprising:
a support member having a recess extending in a longitudinal direction of the support member; and
a rail member;
wherein the rail member is disposed in the recess of the support member and is mechanically coupled to the support member; and
wherein the rail member includes a receiving space for receiving and holding loads.

2. The mounting rail of claim 1,
wherein the support member is made of a first material;
wherein the rail member is made of a second material; and
wherein the first material is a different material than the second material.

3. The mounting rail of claim 1,
wherein the support member comprises at least one material selected from the group consisting of: Aluminum, an aluminum alloy, a plastic, a carbon fiber reinforced plastic; and
wherein the rail member comprises at least one material selected from the group consisting of: Aluminum, an aluminum alloy, titanium, a titanium alloy.

4. The mounting rail of claim 1, wherein the support member comprises at least two support members arranged in the longitudinal direction of the mounting rail and adjoining one another, the support members mechanically connected to one another so that the recesses of the support members adjoin one another.

5. The mounting rail of claim 1, wherein the rail member comprises at least two rail members arranged in the recess.

6. The mounting rail of claim 5, wherein the two rail members are configured differently.

7. The mounting rail of claim 1, wherein the rail member is held in the support member in the form of a dovetail joint.

8. The mounting rail of claim 1, wherein the rail member is fixed in the recess of the support member with one or more fastening members, such that movement of the rail member in the longitudinal direction of the recess is prevented.

9. The mounting rail of claim 1, wherein the receiving space of the rail member is configured to form a first installation space for conduits in addition to receiving loads.

10. The mounting rail of claim 1, wherein the support member comprises two support legs extending away from the recess and configured to form and partially enclose a second installation space for conduits.
